(19) United States
(12) Patent Application Publication
(10) Pub. No.: US 2012/0246622 A1
(43) Pub. Date: Sep. 27, 2012

(54) STORAGE OF SOFTWARE EXECUTION DATA BY BEHAVIORAL IDENTIFICATION

(76) Inventor: Neil PUTHUFF, Ladera Ranch, CA (US)

(21) Appl. No.: 13/428,597

(22) Filed: Mar. 23, 2012

Related U.S. Application Data
(60) Provisional application No. 61/466,828, filed on Mar. 23, 2011.

(51) Int. Cl. G06F 11/36

(52) U.S. Cl. 717/127

(57) ABSTRACT

A method and system for identifying behavioral uniqueness of software execution sequence. The method comprises the steps of executing a software program and continuously producing an execution sequence of execution information, determining if the execution information is within a functional boundary of the software program, and determining if the execution sequence of the execution information is a new execution sequence or a repeat execution sequence. The system comprises a functional boundary detector for continuously analyzing an execution information of a software program to determine if the execution information is within a functional boundary of said software program, and a comparator provided for determining if an execution sequence of the execution information is a new execution sequence or a repeat execution sequence and producing a unique detection signal if the new execution sequence is detected.

### CROSS-REFERENCE TO RELATED APPLICATION

This Application claims the benefit under 35 U.S.C. 119(e) of U.S. Provisional Application Ser. No, 61/466,828 filed Mar. 23, 2011 by Puthuff, N., which is hereby incorporated herein by reference in its entirety.

### BACKGROUND OF THE INVENTION

1. Field of the Invention

The present invention relates to development and analysis of computer software in general, and more particularly to a method and system for identifying behavioral uniqueness of software execution sequences as a basis for collection and storage of software execution data and related information.

2. Description of the Related Art

Software applications are created from source code that is written by software developers. In the process of writing software, many defects are unintentionally introduced into the software code. These defects are generally referred to as “bugs”, and can be very difficult to isolate and understand using prior art tools and methods.

Throughout the over 50 year history of programmable computers, software developers have relied on tools and methods of conditional debugging, wherein a predetermined condition, or a predetermined sequence of conditions must be satisfied before enabling the capture of program execution data. Examples of conditional debuggers include breakpoint debuggers (wherein one or more predefined breakpoint conditions are set at fixed locations in the software code to enable data capture), single-step debuggers (wherein program code can be stepped instruction-by-instruction, resulting in manual data capture at instruction boundaries), print debugging (wherein the target software has additional instructions inserted to export data from predetermined locations), and real-time trace debuggers (wherein dedicated circuitry performs the real-time export of software execution data while the computer system is running at full speed, and includes triggering circuitry to enable data capture around a predefined condition or a predefined sequence of conditions).

The major shortcoming of conditional debugging is that the developer must know in advance the exact condition around which to capture data for each and every behavior of interest that the software exhibits. An example of this is in software debugging: a software developer becomes aware of some defect or undesirable behavior of the software under development, and begins searching for its cause. A breakpoint condition or trigger condition is devised and set based on the developers best guess of the possible cause of the incorrect behavior. The software program is then executed until the undesirable behavior occurs or the breakpoint or trigger condition is satisfied and execution data is collected, but if neither of these outcomes results in execution data capture that reveals the underlying cause of the incorrect behavior, the breakpoint or trigger condition must be modified to more-correctly match the conditions of the incorrect behavior and the process is repeated. This is an iterative process that can take hours or days to complete, resulting in the correction of just one software defect.

To better illustrate the shortcomings of conditional debugging methods, consider the example of a small software function:

int example(char x, char y, char z)
{

int rtnVal = 0;
switch(z) {

case 0: rtnVal = (x−y); break;
case 1: rtnVal = ((int)(x*100)) / (x+y); break:
case 2: rtnVal = (x<<y); break;
case 3: rtnVal = 100; break;

}
return rtnVal;

}

From initial inspection it might be expected that this function could behave in only 4 possible ways: one for each ‘case’ statement reached by evaluating argument ‘z’. Using prior-art conditional debugging tools would likely support this expectation; a breakpoint or trigger could be set at the entry point of the function or at each ‘case’ statement to verify that each condition is reached and that the function behaves as expected. However, there are additional behaviors to this example function that can be difficult to detect using conditional debugging methods. First, there is no ‘default’ condition for the swatch statement, so if the value of argument ‘z’ is at any time something other than 0, 1, 2, or 3 then no case statement will be reached—the ‘switch’ statement will fall-through and return a 0, which may result effects ranging from benign to catastrophic. Second, if the sum of arguments ‘x’ and ‘y’ result in a value of 0 when argument ‘z’ is set to 1, the result will be a divide-by-zero exception in the computer system, which is generally viewed as a catastrophic error condition. Third, if argument ‘y’ is greater than 31 when argument ‘z’ is 2, the overflow of the shift operation will cause the return value to be 0 or −1 regardless of the value of argument ‘x’. Any of these behaviors can be very difficult to correct using conditional-capture methods; their effects may be so catastrophic (such as a system reset) that they eradicate the evidence of the cause of the error or so benign that nobody notices that something is incorrect, or happen so infrequently that they cannot be reproduced within a reasonable time frame. Note that this is a very simple example function used for illustration purposes; actual software application code is generally much more complex and has more potential behaviors.

Recent improvements in conditional debuggers involving the collection of large quantities of real-time trace data show some promise as a more effective means of software debugging. These systems use fixed-size buffers of up to 4 gigabytes for high-bandwidth collection of several seconds of execution data, or employ spool-to-disk methods for low-bandwidth execution data collection over extended periods. The captured data can then be analyzed to obtain profiling or code coverage information, or replayed as though debugging a live computer target. For example, Lauterbaeh GmbH's “Real-time Streaming (ETMv3)” technology performs extended-duration recording of real-time trace data and creates profiling and code coverage summaries on-the-fly. Execution profiling and code coverage is useful and has been available for many years, but neither of these will detect the individual behaviors of the called functions, and will not detect unintended behaviors such as those discussed in the above example function. These incorrect behaviors will be included in the profiling and coverage summaries just like any other functional iteration. This crucial shortcoming is inherent in all conditional debuggers: they do not detect variations in the behavior of the software, nor do they use it as a basis for data collection.

A large number of the problems of software development—high development costs, unpredictable development scheduling, and low resulting software quality—can be directly attributed to the ineffectiveness of conditional debugging systems and methods. These methods have failed to be effective for decades, and there is no reasonable expectation that they will be a solution as applications continue to grow.

### SUMMARY OF THE INVENTION

The present invention is directed a method and system for identifying behavioral uniqueness of software execution sequences as a basis for collection and storage of software execution data and related information.

A first aspect of the invention provides a method for identifying behavioral uniqueness of software execution sequences as a basis for collection and storage of software execution data and related information. The method comprises the steps of executing a software program and continuously producing an execution sequence of execution information, determining if the execution information is within a functional boundary of the software program, and determining if the execution sequence of the execution information is a new execution sequence or a repeat execution sequence.

A second aspect the invention provides a system for identifying behavioral uniqueness of software execution sequences. The system comprises a functional boundary detector for continuously analyzing an execution information of a software program to determine if the execution information is within a functional boundary of said software program, and a comparator provided for determining if an execution sequence of the execution information is a new execution sequence or a repeat execution sequence and producing a unique detection signal if the new execution sequence is detected.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, wherein:

FIG. 1 is an overview block diagram showing major components of system and method according to the exemplary embodiment of the present invention;

FIG. 2 is a detailed block diagram of the exemplary embodiment of the system and method according to the present invention;

FIG. 3 is a detailed block diagram of a behavioral identifier calculation system according to the exemplary embodiment of the present invention;

FIG. 4 is a block diagram of a behavior uniqueness detecting method according to the exemplary embodiment of the present invention; and

FIG. 5 is a block diagram of the system according to the present invention having with a multi-user storage system.

### DESCRIPTION OF EXEMPLARY EMBODIMENTS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part, of the entire written description. The word “a” as used in the claims means “at least one” and the word “two” as used in the claims means “at least two”.

A method and system for identifying behavioral uniqueness of software execution sequences as a basis for collection and storage of software execution data and related information according to the exemplary embodiment of the present invention will be described in detail with reference to the accompanying drawings.

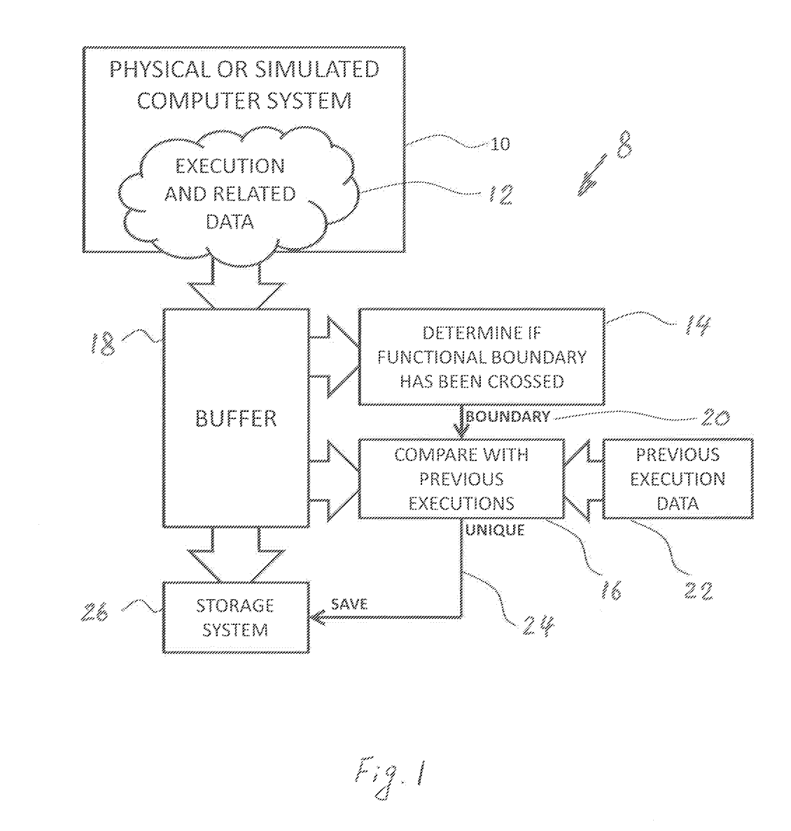

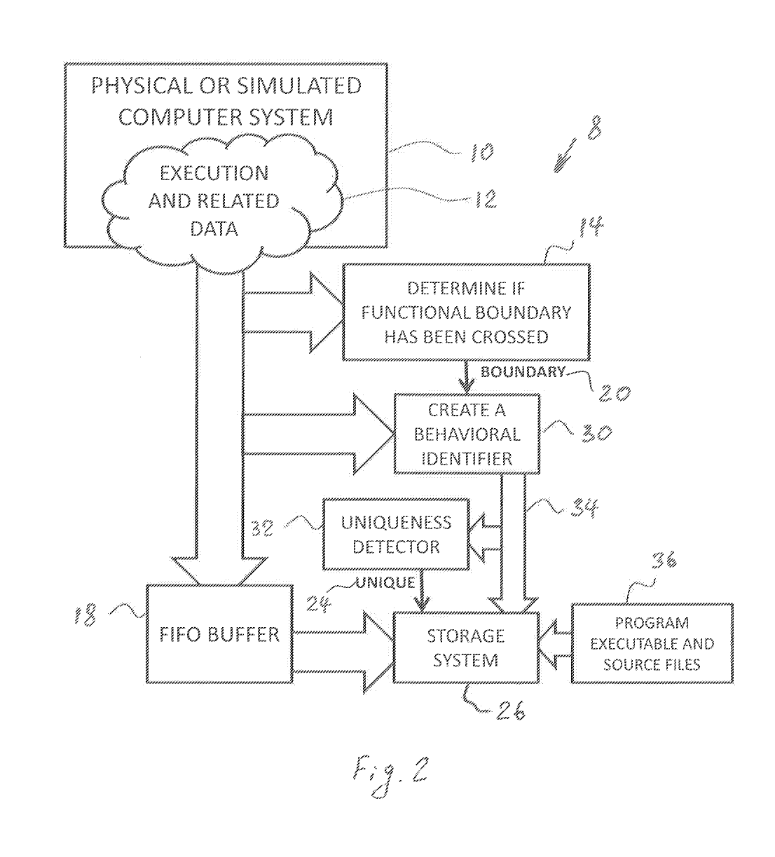

FIGS. 1 and 2 schematically illustrate an overview block diagram of a system and method according to the exemplary embodiment of the present invention.

Referring to FIG. 1, the system of the present invention, generally depicted by the reference numeral 8, comprises a computer system 10 (physical or simulated) executing one or more software programs of interest, a functional boundary detector 14, a comparator 16 and a data buffer 18. In the process of executing the software program, execution information 12 (including execution data and related information) is continuously created by the computer system 10. This execution information 12 is continuously collected and presented to both the functional boundary detector 14 and the comparator 16 through the data buffer 18. Within the boundary detector 14 the execution information is continuously analyzed to determine if a functional boundary within the software program, such as function calls, call stacks, context swatches, etc., have been crossed. In other words, the functional boundary detector 14 is provided to determine if the execution information is within a functional boundary of the software program. If the functional boundary is detected, the boundary detector 14 asserts the boundary detection signal 20, which signals the comparator 16 to continuously evaluate the contents of the preceding execution segment against the contents of the previous execution information from a previous execution data buffer 22 to determine if an execution sequence of the execution information has been previously observed, or if this is new, unique behavior. The previous execution data buffer 22 sores the previous execution information. If the behavior is determined to be unique (i.e. new, not previously observed), the comparator 16 produces a unique detection signal 24, which instructs a storage system 26 to store the related data contents in the data buffer 18, and a behavioral identifier, generated by the comparator 16, in the data buffer 18 for future comparisons.

FIG. 2 depicts a more detailed view into the internal operations of the exemplary embodiment of the present invention. Similar to FIG. 1, the computer system 10 produces the execution information 12, which may be composed of any combination of execution trace information, program variables, memory accesses, I/O operations, execution timing, and other related signals, events, or conditions. This execution information 12 is presented to the functional boundary detector 14, the data buffer 18, and the contents of the comparator 16, represented in FIG. 2 as a behavioral identifier creation logic 30 and a uniqueness detector 32. The behavior identifier creation logic 30 is provided to sequentially process the execution and related data (i.e., the execution information) using arithmetic and/or logic operations to produce a behavioral identifier 34 of the execution data sequence 12 for the period defined between the boundaries established by the boundary detection signal 20. When complete, the behavioral identifier 34 is presented to the uniqueness detector 32, composed of the comparator 16 and the previous execution data buffer 22 (both shown in FIG. 1), to determine if the related behavioral identifier of the is a repeat of previous behavioral identifiers (previous execution sequences), or represents new behavioral identifier (new execution sequence). If the behavior is unique, the unique detection signal 24 is asserted, instructing the storage system 26 to save the related execution data sequence contained in the FIFO (First In, First Out) buffer 18 along with the behavioral identifier 34, and the behavioral identifier 34 is saved in the previous execution data buffer (or store) 22. Additionally, related program source files and executable software images 36 are also stored in the storage system 26 to enable future replay, analysis, or visualization using the correct source and executable files for selected behaviors, even if those files receive many edits and modifications during development.

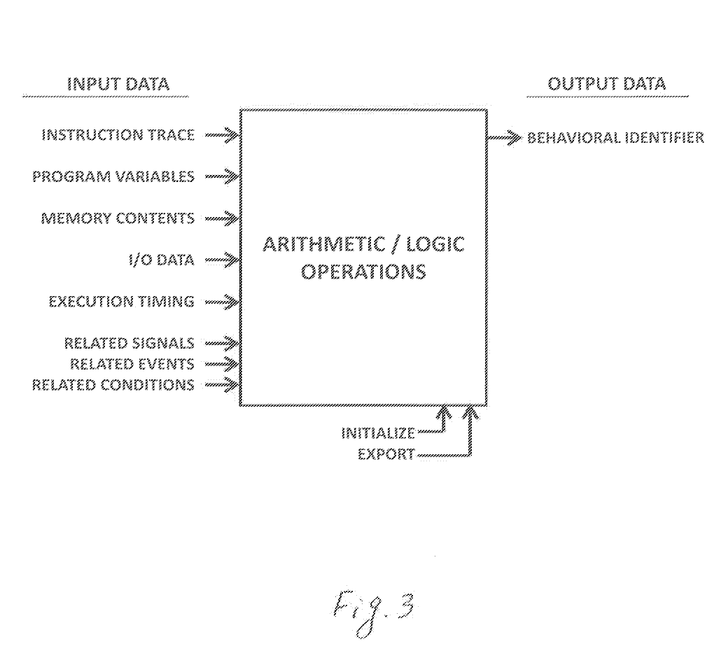

FIG. 3 depicts the dataflow in the behavioral identifier 30. Input data from a variety of sources that are affected by or have an effect on the software execution are candidates for input data to create the behavioral identifiers. Instruction trace is a preferred source of the input data as it provides the most direct indication of the software behavior, however distinctive identifiers can be obtained from alternate combinations of sources, such as program variables and execution timing. The internal arithmetic/logic operation performed on the input data within the behavioral identifier 34 can vary depending on implementation conditions, from simple checksums or CRC (cyclic redundancy check) totals, cumulative hashes such as MD5, or even a minimally-processed linear representation of the input data, Any of these approaches may be suitable provided they produce consistent identifiers for repeated input sequences.

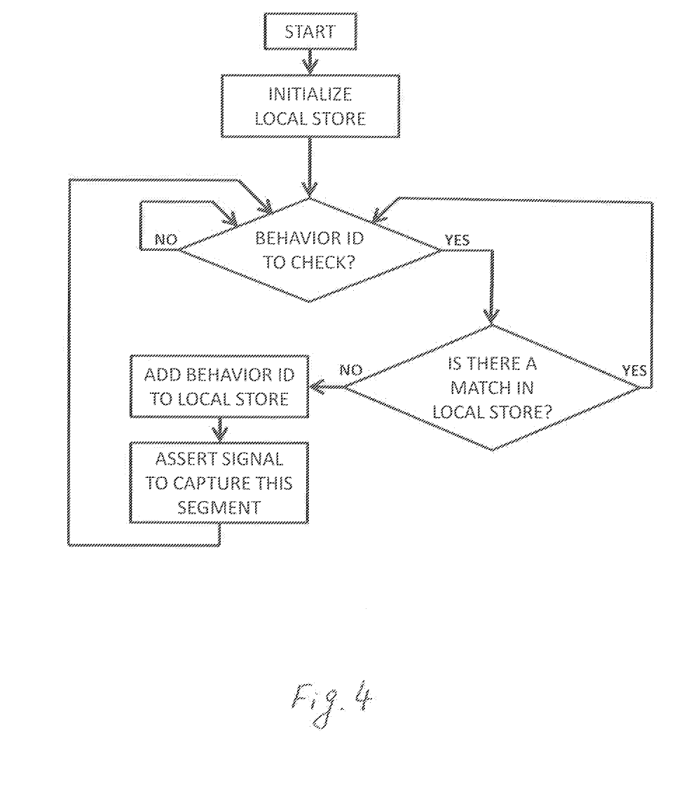

FIG. 4 depicts a decision flow within the comparator 16, which implements a non-duplicating memory set with detection for new item addition. It will be appreciated that a local behavioral identifier store can be initialized with previously-recorded values to prevent the re-recording of these execution sequences, saving capacity for only recording previously-unseen execution sequences.

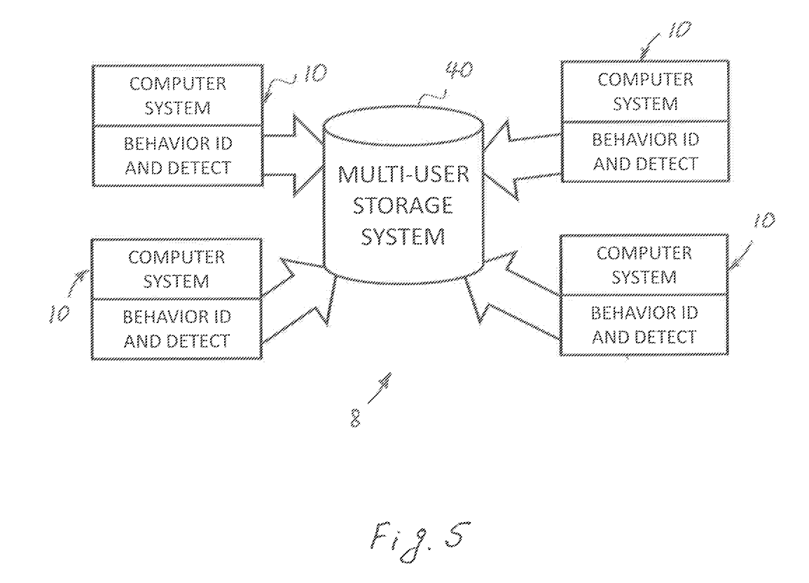

FIG. 5 depicts the exemplary embodiment of the present invention using a multi-user storage system such as a database or distributed file system. In FIG. 5, individual computer systems 10 paired with the behavior identification and uniqueness detection systems of the present invention have their resulting behavioral identifiers and related execution information, source files, and executable software images stored in a multi-user storage system 40. This arrangement shares the collected execution information among all users, making a defect or other unique behavior that happens on any connected computer system immediately available to all users.

Therefore, the present invention provides a novel method and system for identifying behavioral uniqueness of software execution sequences as a basis for collection and storage of software execution data and related information. The present invention uses software behavioral identification as the basis for the collection and storage of software execution data. Execution information is continuously analyzed to determine if a behavioral iteration of the computer program is unique or merely a repeat of previously-observed behavior. When a unique behavior is detected, the data of interest is captured and stored, indexed by that behavioral identifier. The input data used to create this behavioral identification may include but is not limited to: execution trace data, program variables, execution timing, and related signals, conditions, and events. These data values are progressively combined into a behavioral identifier as the program executes, and exported on software functional boundaries to be evaluated for uniqueness. Using the example software function described above, the present invention would uniquely identify every executed behavioral variant, to include all 4 case statements and the 3 additional behaviors if actually executed. A software developer could then review the collected behaviors at their leisure to determine if the behavior is correct or incorrect.

The benefits of the behavioral capture method of the present invention over the conditional capture methods of prior art are far-reaching. First, software developers no longer have to set conditional breakpoints or triggers in an iterative attempt to capture evidence of just one incorrect software behavior after another, since every behavior is automatically captured the first time it happens. This nearly eliminates the most expensive component of software development: finding and fixing software bugs. Second, since every behavior is uniquely identified and captured, including incorrect behaviors with otherwise subtle symptoms or low recurrence rates, then these defects can be corrected as soon as they happen at least one time. The result is greatly improved software quality, with very low residual defect rates achievable without undue expense. Third, this identification and capture can be performed on the entirety of executing software, not just those functions of interest to an individual developer. This enables an intimate knowledge of unfamiliar code to be gained quickly by a software developer, a process that is very difficult using prior art methods.

The method according to the present invention accesses execution trace data of a computer system. This trace data is analyzed to determine program functional boundaries. A behavioral identifier variable is initialized to a base value at the start of a program functional boundary. During execution within a program functional boundary, the execution trace data and other related data of interest is progressively combined with the behavioral identifier variable using arithmetic and/or logical operations until the end of the program functional boundary, at which point the behavioral identifier variable is exported to a behavior uniqueness detector. The behavior uniqueness detector maintains a store of behavioral identifiers to be compared with the newly presented behavioral identifiers as a test of uniqueness. If the presented identifier does not exist in the store, it is added to the store and a signal is asserted that the behavior is unique, and the associated execution data around and including the unique behavior should be captured and stored in a storage system, such as a database, file system, or similar.

Further according to the present invention, pre-collected execution data is analyzed to create unique behavioral identifiers corresponding to functional boundaries within the target software program. These identifiers can then be used to index the pre-collected data, to eliminate duplicate behavior sequences from the pre-collected execution data, or in the creation of a common index for multiple buffers of pre-collected execution data.

Moreover, the sequence of the behavioral identifiers may be stored in the storage system sequentially as they appear. This enables a continuous reconstruction of the entirety of observed software execution to be created from the data in the storage system.

Also according to the present invention, the relevant executable software image and associated source files are also saved in the storage system, thus facilitating the anytime retrieval, reconstruction, and replay of the entirety of captured execution behaviors. This enables the on-demand replay, analysis, and visualization of not only all behaviors of all executed software functions, but also of every revision of every executed software function, using the correct source files and program image for reconstruction and presentation in a replay debugger or analyzer. This results in the creation of a self-assembling knowledge base of the entirety of behaviors exhibited by the target software, spanning all changes incurred during development and maintenance. Prior-art tools and methods routinely discard this valuable execution data, and generally provide no facility for correlated storage of the associated source and executable files.

Further according to the present invention, the storage system may be a multi-user or distributed store, thereby enabling the execution behaviors observed within multiple systems to be combined into a single database that is accessible to many users. This yields some unexpected results: a software defect that happens on any system that adds to the common store is immediately made available to all users. With prior-art methods, developers work in isolation and collected execution data is not shared among users. The present invention enables a team synergy that was never before possible: all developers contribute their collected software behavior data to the common store automatically, so as they execute software on a target system, seeking to quickly expose as many defects as possible in their own code, they're also executing other parts of the target software that may contain code written by others—potentially exposing new behaviors that had not been seen before. The result is that every developer becomes a tester of other developers' code without expending any extra effort.

The foregoing description of the exemplary embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A method for identifying behavioral uniqueness of software execution sequence, said method comprising the steps of:
executing a software program and continuously producing an execution sequence of execution information;
determining if said execution information is within a functional boundary of said software program; and
determining if said execution sequence of said execution information being a new execution sequence or a repeat execution sequence.

2. The method according to claim 1, further comprising the step of continuously comparing said execution sequence of said execution information of a current execution segment of said software program with said execution sequence of said execution information of a preceding execution segment of said software program; said step preceding to the step of determining if said execution sequence of said execution information is said new execution sequence.

3. The method according to claim 1, further comprising the step of producing a unique detection signal if said new execution sequence is detected.

4. The method according to claim 1, further comprising the step of continuously buffering an execution sequence of said execution information generated by said software program.

5. The method according to claim 3, wherein the step of comparing said execution sequence of said execution information comprises the steps of:
sequentially processing said execution information using arithmetic and/or logic operations to produce a behavioral identifier of said execution sequence; and
determining if said behavioral identifier is a repeat of previous behavioral identifier or represents a new behavioral identifier.

6. The method according to claim 5, further comprising the step of storing said behavioral identifier for future comparisons.

7. The method according to claim 6, wherein said behavioral identifier is stored for future comparisons in response to said unique detection signal.

8. A system for identifying behavioral uniqueness of software execution sequence, said system comprising:
a functional boundary detector for continuously analyzing an execution information of a software program to determine if said execution information is within a functional boundary of said software program; and
a comparator provided for determining if an execution sequence of said execution information is a new execution sequence or a repeat execution sequence, and producing a unique detection signal if said new execution sequence is detected.

9. The system according to claim 8, further comprising a data buffer continuously collecting said execution information.

10. The system according to claim 9, wherein said data buffer is a FIFO (First In, First Out) buffer.

11. The system according to claim 9, further comprising a storage system storing said execution information related to said new execution sequence from said data buffer.

12. The system according to claim 9, wherein said data buffer supplies said execution information to said functional boundary detector and said comparator.

13. The system according to claim 8, further comprising a previous execution data buffer storing said execution sequence of said execution information of a preceding execution segment of said software program.

14. The system according to claim 13, wherein said comparator further continuously compares said execution sequence of said execution information of a current execution segment of said software program with said execution sequence of said execution information of said preceding execution segment of said software program in order to determine if said execution sequence of said execution information is said new execution sequence.

15. The system according to claim 8, wherein said comparator including a behavioral identifier creation logic and a uniqueness detector;
said behavioral identifier creation logic provided to sequentially process said execution information using arithmetic and/or logic operations to produce a behavioral identifier of said execution sequence;
said uniqueness detector receives said behavioral identifier from said behavioral identifier creation logic to determine if said behavioral identifier is a repeat of previous behavioral identifier or represents a new behavioral identifier.

16. The system according to claim 15, further comprising a storage system to store said behavioral identifier in said data buffer for future comparisons.

17. The system according to claim 16, further comprising a data buffer continuously collecting said execution information; wherein said storage system receives and stores said execution information related to said new execution sequence from said data buffer.
